(19) United States
(12) Patent Application Publication
(10) Pub. No.: US 2026/0113572 A1
(43) Pub. Date: Apr. 23, 2026

(54) METHOD FOR NONLINEARLY CONTROLLING AND COMPENSATING INTERMODULATION DISTORTION OF SOUNDING ELEMENT, DEVICE, AND MEDIUM

(71) Applicant: AAC Acoustic Technologies (Shanghai) Co., Ltd., Shanghai (CN)

(72) Inventors: Nan Cao, Shanghai (CN); Lijian Ye, Shanghai (CN); Hongxing Wang, Shanghai (CN)

(21) Appl. No.: 19/008,589

(22) Filed: Jan. 2, 2025

Related U.S. Application Data
(63) Continuation of application No. PCT/CN2024/126263, filed on Oct. 22, 2024.

(51) Int. Cl. H04R 3/02

(52) U.S. Cl. CPC H04R 3/02

(57) ABSTRACT

Embodiments of the present disclosure relates to the field of noise compensation, and disclose a method for nonlinearly controlling and compensating intermodulation distortion of a sounding element, a device, and a medium. The present disclosure obtains a sound source with an excitation signal obtained by mixing multiple frequencies, uses test sound pressure response data corresponding to the excitation signal as training set data, and performs intermodulation distortion compensation on the sounding element with trained intermodulation distortion model. According to the method, the response results of the sound sources under different excitation signals can be obtained through training, then the compensation related parameters for the intermodulation distortion are determined, thereby compensating the intermodulation distortion of the sounding element with the intermodulation distortion model, removing the noise of the sounding element, and thus improving user's auditory experience.

### TECHNICAL FIELD

Embodiments of the present disclosure relate to the field of noise compensation, and in particular to a method for nonlinearly controlling and compensating intermodulation distortion of a sounding element, a device, and a medium.

### BACKGROUND

Currently, smart devices are mostly provided with sounding elements, such as mobile phones, earphones, and smart appliances. In the sounding process of the sounding element, if the low-frequency signal components and the high-frequency signal components appear simultaneously, due to the influence of Doppler effect and element nonlinearity, intermodulation distortion can be generated between the low-frequency signal and the high-frequency signal, resulting in blurry information output by the sounding element, or the appearance of noise or abnormal sound, which is not conducive to the user's auditory experience.

### SUMMARY

An objective of the embodiments of the present disclosure is to provide a method for nonlinearly controlling and compensating intermodulation distortion of sounding element, a device and a medium, to compensate for intermodulation distortion with a trained intermodulation distortion model, thereby eliminating noise of the sounding element, and thus improving user's auditory experience.

To solve the above technical problem, an embodiment of the present disclosure provides a method for nonlinearly controlling and compensating intermodulation distortion of a sounding element, and the method includes: acquiring a sound source with an excitation signal obtained by mixing multiple frequencies, taking test sound pressure response data corresponding to the excitation signal as training set data, and performing intermodulation distortion compensation on at least one sounding element with the trained intermodulation distortion model.

An embodiment of the present disclosure provides an electronic device, and the electronic device includes at least one processor and a memory communicatively connected to the at least one processor. The memory stores instructions executable by the at least one processor, and the instructions, when executed by the at least one processor, enables the at least one processor to perform a method for nonlinearly controlling and compensating intermodulation distortion of a sounding element. The method includes: acquiring a sound source with an excitation signal obtained by mixing multiple frequencies, taking test sound pressure response data corresponding to the excitation signal as training set data, and performing intermodulation distortion compensation on at least one sounding element with the trained intermodulation distortion model.

An embodiment of the present disclosure provides a computer-readable storage medium storing a computer program. The computer program, when executed by a processor, performs a method for nonlinearly controlling and compensating intermodulation distortion of a sounding element. The method includes: acquiring a sound source with an excitation signal obtained by mixing multiple frequencies, taking test sound pressure response data corresponding to the excitation signal as training set data, and performing intermodulation distortion compensation on at least one sounding element with the trained intermodulation distortion model.

Compared with the related art, according to the embodiments of the present disclosure, the sound source with the excitation signal by mixing multiple frequencies and the test sound pressure response data corresponding to the excitation signal are obtained as the training data, to train the intermodulation distortion model. According to the method, the response results of the sound sources under different excitation signals can be obtained through training in this way, then the compensation related parameters for the intermodulation distortion are determined, thereby compensating the intermodulation distortion of the sounding element with the intermodulation distortion model, removing the noise of the sounding element, and thus improving user's auditory experience.

As an improvement, the intermodulation distortion model includes an identification distortion parameter and a controller parameter. The identification distortion parameter is a parameter representing an intermodulation distortion generated under the excitation signal obtained by mixing the sound source with multiple frequencies, and the controller parameter is a parameter for compensating the intermodulation distortion.

As an improvement, the identifying distortion parameter and the controller parameter includes: a time variant linear parameter/a time invariant linear parameter, and/or a time variant nonlinear parameter.

As an improvement, the excitation signal is an audio signal generated by driving an electrical signal, a force signal, or a sound pressure.

As an improvement, the method includes: determining controller parameters respectively corresponding to a plurality of sounding elements with the intermodulation distortion model when performing intermodulation distortion compensation on the plurality of sounding elements, the at least one sounding element including the plurality of sounding elements; calculating target compensation signals used to perform intermodulation distortion compensation on the plurality of sounding elements with the controller parameters respectively corresponding to the plurality of sounding elements; and adding the target compensation signals to a sound source of a target sounding element of the plurality of sounding elements, to perform intermodulation distortion compensation on the plurality of sounding elements.

As an improvement, determining the target sounding element includes: selecting, according to control difficulties of the sounding elements, one sounding element, with a low control difficulty, of the plurality of sounding elements as the target sounding element.

As an improvement, the method includes: if the sound source of one sounding element of the at least one sounding element comprises contents of different operation regions, determining controller parameters respectively corresponding to the different operation regions with the intermodulation distortion model when the sound source of the sounding element comprises content of different operation regions; and selecting a corresponding controller parameter of the controller parameters to perform intermodulation distortion compensation according to the operation region of the corresponding sounding element. In this way, different controller parameters can be selected in a targeted manner for the operation region of the sounding element, thereby improving the denoising effect.

As an improvement, the method includes: if the sound source of one sounding element of the at least one sounding element comprises contents of different operation regions, determining, using the intermodulation distortion model, controller parameters comprising at least two operation regions of the different operation regions sounding element; and performing intermodulation distortion compensation according to the controller parameters.

### BRIEF DESCRIPTION OF DRAWINGS

One or more embodiments are exemplarily illustrated by pictures in the accompanying drawings corresponding thereto. These exemplary descriptions do not constitute limitations on the embodiments of the present disclosure. Elements with the same reference numerals in the accompanying drawings are denoted as similar elements, unless otherwise stated. The pictures in the drawings do not constitute a proportional limitation.

FIG. 1 is a flowchart of a method for nonlinearly controlling and compensating intermodulation distortion of a sounding element according to a first embodiment of the present disclosure;

FIG. 2 is an overall flowchart of a method for nonlinearly controlling and compensating intermodulation distortion of a sounding element according to a first embodiment of the present disclosure;

FIG. 3 is a flowchart of a method for nonlinearly controlling and compensating intermodulation distortion of a sounding element according to a second embodiment of the present disclosure;

FIG. 4 is a flowchart of a process of determining the identifying distortion parameters and the controller parameters according to a second embodiment of the present disclosure;

FIG. 5 is a flowchart of a process of intermodulation distortion compensation of a sounding element according to a second embodiment of the present disclosure;

FIG. 6 is a flowchart of a method for nonlinearly controlling and compensating intermodulation distortion of a sounding element according to a second embodiment of the present disclosure;

FIG. 7 is a flowchart of a process of determining the identifying distortion parameters and the controller parameters in an overall compensation manner according to a third embodiment of the present disclosure;

FIG. 8 is a flowchart of an intermodulation distortion compensation process of a sounding element in an overall compensation manner according to a third embodiment of the present disclosure;

FIG. 9 is a flowchart of a process of determining the identifying distortion parameters and the controller parameters in compensation manners of different operation regions according to a third embodiment of the present disclosure;

FIG. 10 is a flowchart of an intermodulation distortion compensation process of a sounding element in compensation manners of different operation regions according to a third embodiment of the present disclosure; and

FIG. 11 is a schematic structural diagram of an electronic device according to an embodiment of the present disclosure.

### DESCRIPTION OF EMBODIMENTS

In order to make the objectives, technical solutions and advantages of the embodiments of the present disclosure clearer, various embodiments of the present disclosure will be described in detail below with reference to the drawings. However, those skilled in the art will appreciate that in various embodiments of the present disclosure, numerous technical details are set forth for the reader to better understand the present disclosure. However, even without these technical details and various changes and modifications based on the following embodiments, the technical solutions claimed in the present disclosure can still be implemented.

The following embodiments are divided for ease of description, and should not constitute any limitation on specific embodiments of the present disclosure, and the embodiments can be mutually incorporated by reference without contradiction.

The first embodiment of the present disclosure relates to a method for nonlinearly controlling and compensating intermodulation distortion of a sounding element. The core of this embodiment is to acquire a sound source with an excitation signal obtained by mixing multiple frequencies, take test sound pressure response data corresponding to the excitation signal as training set data, and perform intermodulation distortion compensation on at least one sounding element with the trained intermodulation distortion model. According to the method, the response results of the sound sources under different excitation signals can be obtained through training, then the compensation related parameters for the intermodulation distortion are determined, thereby compensating the intermodulation distortion of the sounding element with the intermodulation distortion model, removing the noise of the sounding element, and thus improving user's auditory experience. The implementation details of the method for nonlinearly controlling and compensating intermodulation distortion of the sounding element of the present embodiment are described in detail below, and the following content is only implementation details provided for ease of understanding, and is not necessary for implementing this solution.

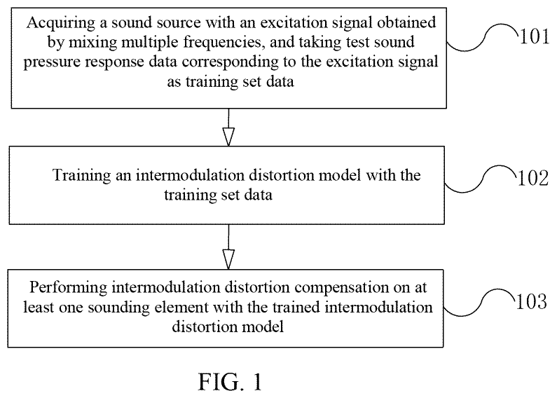

The method for nonlinearly controlling and compensating intermodulation distortion of the sounding element in this embodiment is shown in FIG. 1, and includes the following Steps 101-103.

At step 101, a sound source with an excitation signal obtained by mixing multiple frequencies is acquired, and test sound pressure response data corresponding to the excitation signal is taken as training set data.

The sound source can be collected by one or more sounding elements. Sound sources of multiple frequencies can be one or more signal types of a direct current signal, a low frequency signal, a high frequency signal, a noise signal, and the like. The excitation signal is an audio signal generated by driving an electrical signal, a force signal, or a sound pressure.

At step 102, an intermodulation distortion model is trained with the training set data.

The intermodulation distortion model includes an identification distortion parameter and a controller parameter. The identification distortion parameter is a parameter representing intermodulation distortion generated by mixing the sound source with multiple frequencies to obtain an excitation signal. The controller parameter is a related parameter configured to compensate the intermodulation distortion and thus compensating a sound source of the sounding element. As an improvement, the identifying distortion parameter and the controller parameter includes a time variant linear parameter/a time invariant linear parameter, and/or a time variant nonlinear parameter. Determining the identification distortion parameter and the controller parameter includes online calculation and offline calculation, and an appropriate calculation manner can be selected according to network condition and calculation amount.

As an improvement, in order to ensure the accuracy of the intermodulation distortion model, a large amplitude needs to be generated at the stage of applying the excitation signal to determine the identification distortion parameter. Since the magnitude of the intermodulation distortion has a certain positive correlation with the magnitude of the amplitude, the large-amplitude test can more effectively obtain parameter information of the intermodulation distortion, that is, obtain a more accurate identification distortion parameter. The stability of the denoising effect of the trained intermodulation distortion model in the actual use process is ensured.

As an improvement, since the sounding element can work in ranges of different operation regions, that is, the sound source can include audio signals in different frequency ranges. When the signals in different operation region ranges are compensated, the compensated output signals are also in the same operation region range in principle. If the sound source is within different operation region ranges, different amplitudes can be generated at the stage of determining the identification distortion parameter. The amplitude of the sounding element can be adjusted with a direct current component. If a proportion of a low-frequency signal in the sound source is relatively high, a higher amplitude needs to be generated. However, when the amplitude is adjusted, the upper limit of the amplitude specified by the sounding element needs to be considered, to avoid damage to the sounding element caused by excessively high amplitude.

At step 103, intermodulation distortion compensation is performed on the sounding element with the trained intermodulation distortion model.

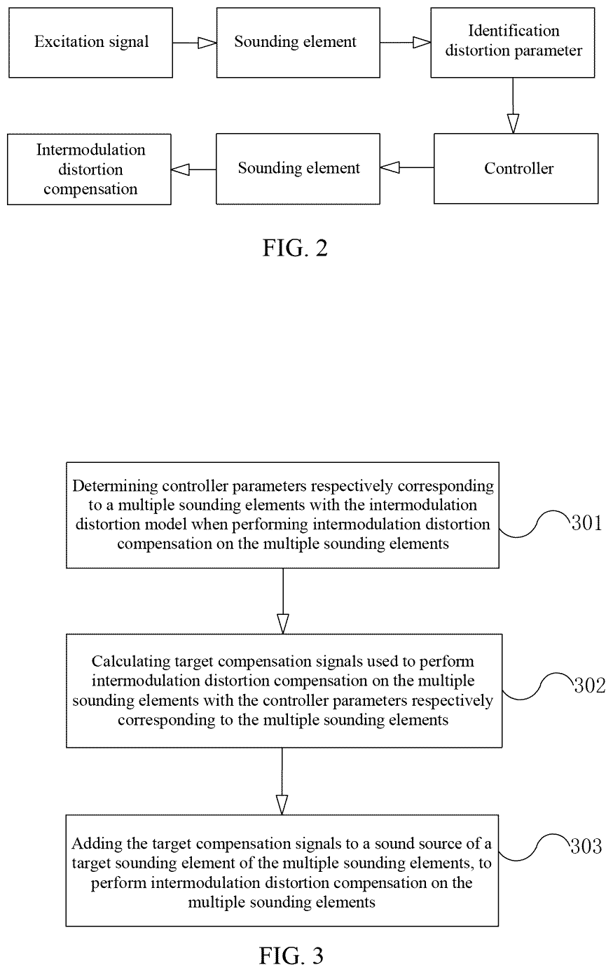

The above content introduces the training method of the intermodulation distortion model. After training the intermodulation distortion model, the trained intermodulation distortion model can be used to compensate the intermodulation distortion of the sound sounding elements. Next, combined with FIG. 2, the overall compensation method for the intermodulation distortion of the sound sounding elements will be explained.

The sounding element is excited by the excitation signal. The intermodulation distortion parameter is identified with the parameter identification module of the intermodulation distortion model, to obtain the identification distortion parameter. The identification distortion parameter is input into the intermodulation compensation control module of an intermodulation distortion model to determine the controller parameter. The controller is designed by utilizing the controller parameter to complete compensation and adjustment of the sounding element.

The design of the controller can be implemented based on an inverse model of the parameter identification module, or by adaptive control or intelligent control.

The excitation signal includes sound sources with multiple frequencies. The sound sources can be one or more types of signals such as direct current signals, low frequency signals, high frequency signals, and noise signals. As an improvement, a large amplitude needs to be generated at the stage of applying the excitation signal to determine the identification distortion parameter. Since the magnitude of the intermodulation distortion has a certain positive correlation with the magnitude of the amplitude, the large-amplitude test can more effectively obtain parameter information of the intermodulation distortion, that is, obtain a more accurate identification distortion parameter. As an improvement, the amplitude of the sounding element can be adjusted to different operation ranges for testing with a direct current component or the like, which facilitates compensation for sounding elements in different operation ranges.

In the compensation stage, the current excitation signal is sent to the sounding element after being adjusted according to the controller parameters through the obtained initial controller. The original sound source of the sounding element can compensate intermodulation distortion and eliminate noise influence caused by intermodulation distortion through the adjusted excitation signal. Since the sound source signal produced by the sounding element changes in real time, after performing the intermodulation distortion compensation at the current moment, online latest parameters of the sounding element can be predicted with the model or fed back with the detector, and compensation processing at the next moment is performed. In this way, real-time compensation of the sounding element is achieved.

A third embodiment of the present disclosure relates to a method for nonlinearly controlling and compensating intermodulation distortion of a sounding element. When performing the intermodulation distortion compensation on multiple sounding elements simultaneously, as shown in FIG. 6, the compensation method includes steps 301-303.

At step 301, controller parameters corresponding to each sounding element with the intermodulation distortion model is determined when performing intermodulation distortion compensation on multiple sounding elements.

At step 302, target compensation signals used to perform intermodulation distortion compensation on the multiple sounding elements is calculated with the controller parameters respectively corresponding to the multiple sounding elements.

At step 303, the target compensation signals ate added to a sound source of a target sounding element of the multiple sounding elements, to perform intermodulation distortion compensation on the multiple sounding elements.

When multiple sounding elements produce sound simultaneously, it can be divided into the following situations based on the volume of the sound sounding elements.

If the volume of one sounding element of the sounding elements 1 has a low volume and the sound produced by the lower volume sounding element 1 can be ignored, it can be regarded that the sounding element 2 independently generates intermodulation distortion. The main function of the sounding element 1 is mainly used as a compensator to eliminate the intermodulation distortion generated by the sounding element 2.

In another case, if the two sounding elements have a same volume and the volume can be heard by human ears, the intermodulation distortion is jointly generated by the sounding element 1 and the sounding element 2. A target compensation signal can be added to a sound source of one of the sounding elements 1, so as to suppress the intermodulation distortion of the sounding element 1 and the sounding element 2 simultaneously, thereby compensating the two sounding elements.

In both of the foregoing cases, a target compensation signal for compensating all the sounding elements is added with one sounding element of the multiple sounding elements. Compared to calculating compensation parameters separately for each sounding element, calculating controller parameters for each sounding element based on the compensation parameter, and compensating each sounding element separately, controlling only one sounding elements can save operation and improve compensation efficiency. Meanwhile, since the noise intervals generated by the multiple sounding elements can have overlapping regions, the compensation operations of the multiple sounding elements are summarized to use the same signal for compensation, which can save resource consumption.

As an improvement, structures of different sounding elements cause differences in impedance curve, sensitivity, phase angle and the like, and these factors can lead to varying levels of difficulty in controlling them. The sounding element with low control difficulty is selected to add the compensation signal into the sound source, thereby reducing the operation difficulty.

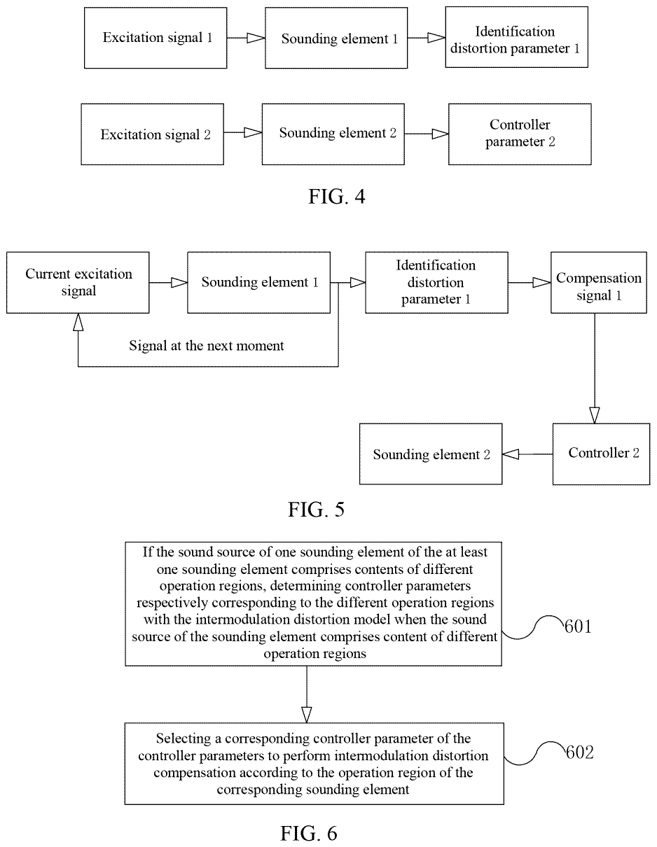

In the case of performing intermodulation distortion compensation for multiple sounding elements, the overall compensation process is as follows. The process of determining the identification distortion parameter and the controller parameter is shown in FIG. 4. The identification distortion parameter 1 of the sounding element 1 is obtained through the excitation signal 1, and the controller parameter 2 of the sounding element 2 is obtained through the excitation signal 2.

The process of the intermodulation distortion compensation of the multiple sounding element is shown in FIG. 5. The identification distortion parameter 1 of the sounding element 1 is obtained with the current excitation signal at the current moment. According to the identification distortion parameter 1, the compensation signal 1 required by the sounding element 1 is determined. The compensation signal 1 is input into the controller 2 of the sounding element 2. The controller 2 of the sounding element 2 determines the target compensation signal according to the controller parameter 2 and the input compensation signal 1, and finally updates the controller parameter 2 according to the target compensation signal, achieving the compensation only for the control of the sounding element 2 at the current moment. At the next moment, the signal of the sounding element changes. The current excitation signal is determined according to the signal of the sounding element 1 at the next moment. The identification distortion parameter 1 is re-calculated according to the re-determined current excitation signal. Then the above process is performed repeatedly to perform real-time compensation on the sounding element.

A third embodiment of the present disclosure relates to a method for nonlinearly controlling and compensating intermodulation distortion of a sounding element. When performing the intermodulation distortion compensation on sounding elements in different operation regions, as shown in FIG. 6, the compensation method includes the following steps.

At step 601, controller parameters respectively corresponding to different operation regions is determined with the intermodulation distortion model when the sound source of the sounding element includes content of different operation regions.

At step 602, the corresponding controller parameter for intermodulation distortion compensation is selected according to the operation region of the sounding element.

As an improvement, since the sounding element can work in ranges of different operation regions, that is, the sound source can include audio signals in different frequency ranges. When the signals in different operation region ranges are compensated, the compensated output signals also need to be in the same operation region range in principle. Therefore, when compensating, it is also necessary to take the operation intervals of the sounding element into account, for example, the sounding element operation in a low-frequency region, a high-frequency region, or at different frequencies generates different signals.

In order to ensure the operation region of the sounding element, the following two manners can be used to compensate the intermodulation distortion of the sounding element. Firstly, the different operation regions of the sounding elements can be regarded as a whole and compensated as a whole. The compensation process is as follows.

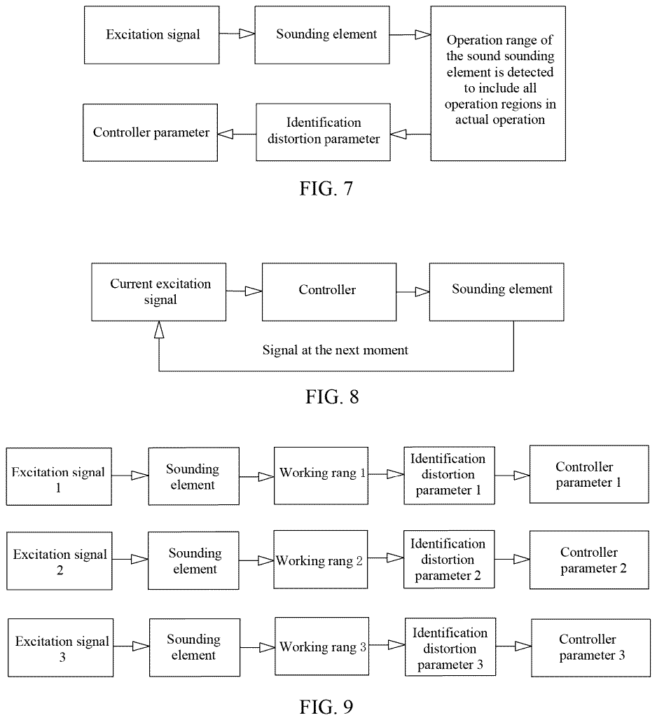

The process of determining the identification distortion parameter and the controller parameter is shown in FIG. 7. By exciting the sounding element with the excitation signal, the operation range of the sound sounding element is detected to include the identified distortion parameters obtained from all operation regions in actual operation. The controller parameter is determined according to the identification distortion parameter.

The process of the intermodulation distortion compensation of the sounding element is as shown in FIG. 8. Based on the determined controller parameters, the current excitation signal is sent to the sounding element after being adjusted by the controller, so as to implement the intermodulation distortion compensation of the sounding element at the current moment. After performing the intermodulation distortion compensation at the current moment, online latest parameters of the sounding element can be predicted with the model or fed back with the detector, and compensation processing at the next moment is performed. In this way, real-time compensation of the sounding element is achieved.

As an improvement, compensation design can also be separately performed according to different operation regions of the sounding element. The specific process is as follows.

A process of determining the identification distortion parameter and the controller parameter is shown in FIG. 9. By using multiple sets of excitation signals to separately excite the sounding element respectively, the identification distortion parameters of the sounding element in different frequency operation ranges (operation regions) are obtained through analysis. The controller parameters in each operation region can be determined according to the identification distortion parameters corresponding to different operation regions. The setting of multiple groups of excitation signals needs to ensure that the sounding element contains a low-frequency signal component and a high-frequency signal component, and the setting of each group of excitation signals needs to enable the sounding element to work in different operation regions.

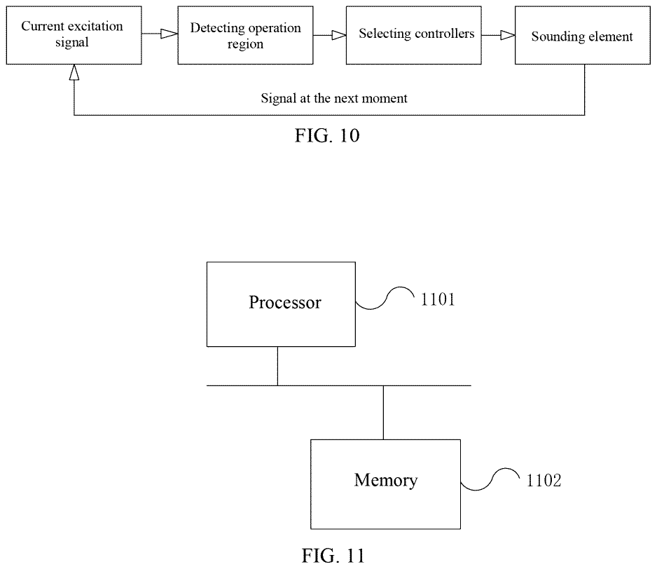

As shown in FIG. 10, an operation range of the sounding element is determined by means of prediction or detector detection. Then a corresponding controller parameter is selected as an initial controller according to the operation range for adjusting a current excitation signal to implement intermodulation distortion compensation of the sounding element. In the compensation process, the distortion parameter and the controller parameter can be continuously and iteratively updated according to the real-time signals detected by the prediction or detector, and the real-time updated sound source signals can be cyclically processed. In the compensation stage, compensation for a single operation range can be implemented with a single initial controller, or multiple initial controllers can be selected to perform comprehensive compensation for multiple operation ranges of the sounding element.

The sounding element mentioned in this embodiment can be an element for audio output, such as a speaker or a loudspeaker.

The steps of the above methods are divided only to describe clearly, and the implementation may be combined into one step or split into several steps, which are all within the protection of the present disclosure as long as the same logical relationship is included. Adding irrelevant modifications to the algorithm or process or introducing irrelevant designs, but not changing the core design of the algorithm and process is within the scope of protection of the present disclosure.

An embodiment of the present disclosure further relates to an electronic device, and, as shown in FIG. 11, the electronic device includes at least one processor 1101 and a memory 1102 communicatively connected to the at least one processor 1101. The memory 1102 stores instructions executable by the at least one processor 1101, and the instructions, when executed by the at least one processor 1101, performs the method for nonlinearly controlling and compensating intermodulation distortion of the sounding element as described above.

The memory 1102 and the processor 1101 are connected by a bus. The bus can include any quantity of interconnected buses and bridges, and connect one or more processors 1101 and various circuits of the memory 1102 together. The bus can also connect various other circuits such as peripherals, voltage regulators, and power management circuits, which are well known in the art. Therefore, it will not be further described herein. The bus interface provides an interface between the bus and the transceiver. The transceiver can be one element, or can be multiple elements, such as multiple receivers and transmitters, providing units for communicating with various other apparatuses over a transmission medium. The data processed by the processor is transmitted over a wireless medium through an antenna, which further receives the data and transmits the data to the processor 1101.

The processor 1101 is configured to manage the bus and general processing, and can provide various functions, including timing, a peripheral interface, voltage regulation, power management, and other control functions. The memory 1102 can be configured to store data used by the processor 1101 when performing operations.

Embodiments of the present disclosure further relates to a computer readable storage medium which stores a computer program. When the computer program is executed by the processor, the foregoing method embodiments are implemented.

That is, those skilled in the art can understand that all or part of the steps in implementing the method in the above embodiments can be implemented by using a program to instruct related hardware, and the program is stored in a storage medium, and includes several instructions used to enable a device (which can be a single-chip microcomputer, a chip, etc.) or a processor to perform all or part of the steps in the methods in the embodiments of the present disclosure. The above storage medium includes: various media that can store program codes, such as USB flash drive, mobile hard disk, read-only memory (ROM), random access memory (RAM), magnetic disk, or optical disk.

Those skilled in the art can understand that the above embodiments are specific embodiments for implementing the present disclosure, and various changes can be made in form and detail in practical applications without departing from the scope of the present disclosure.

What is claimed is:

1. A method for nonlinearly controlling and compensating intermodulation distortion of a sounding element, comprising:
acquiring a sound source with an excitation signal obtained by mixing multiple frequencies, and taking test sound pressure response data corresponding to the excitation signal as training set data;
training an intermodulation distortion model with the training set data;
performing intermodulation distortion compensation on at least one sounding element with the trained intermodulation distortion model.

2. The method for nonlinearly controlling and compensating intermodulation distortion of the sounding element as described in claim 1, wherein the intermodulation distortion model comprises an identification distortion parameter and a controller parameter, wherein the identification distortion parameter is a parameter representing intermodulation distortion generated under the excitation signal obtained by mixing the sound source with multiple frequencies, and the controller parameter is a parameter for compensating the intermodulation distortion.

3. The method for nonlinearly controlling and compensating intermodulation distortion of the sounding element as described in claim 2, wherein the identifying distortion parameter and controller parameter comprises a time variant linear parameter/a time invariant linear parameter, and/or a time variant nonlinear parameter.

4. The method for nonlinearly controlling and compensating intermodulation distortion of the sounding element as described in claim 1, wherein the excitation signal is an audio signal generated by driving an electrical signal, a force signal, or a sound pressure.

5. The method for nonlinearly controlling and compensating intermodulation distortion of the sounding element as described in claim 1, comprising:
determining controller parameters respectively corresponding to a plurality of sounding elements with the intermodulation distortion model when performing intermodulation distortion compensation on the plurality of sounding elements, the at least one sounding element comprising the plurality of sounding elements;
calculating target compensation signals used to perform intermodulation distortion compensation on the plurality of sounding elements with the controller parameters respectively corresponding to the plurality of sounding elements; and
adding the target compensation signals to a sound source of a target sounding element of the plurality of sounding elements, to perform intermodulation distortion compensation on the plurality of sounding elements.

6. The method for nonlinearly controlling and compensating intermodulation distortion of the sounding element as described in claim 5, wherein determining the target sounding element comprises:
selecting, according to control difficulties of the sounding elements, one sounding element, with a low control difficulty, of the plurality of sounding elements-as the target sounding element.

7. The method for nonlinearly controlling and compensating intermodulation distortion of the sounding element as described in claim 1, comprising:
if the sound source of one sounding element of the at least one sounding element comprises contents of different operation regions, determining controller parameters respectively corresponding to the different operation regions with the intermodulation distortion model when the sound source of the sounding element comprises content of different operation regions; and
selecting a corresponding controller parameter of the controller parameters to perform intermodulation distortion compensation according to the operation region of the corresponding sounding element.

8. The method for nonlinearly controlling and compensating intermodulation distortion of the sounding element as described in claim 1, comprising:
if the sound source of one sounding element of the at least one sounding element comprises contents of different operation regions, determining, using the intermodulation distortion model, controller parameters comprising at least two operation regions of the different operation regions sounding element; and
performing intermodulation distortion compensation according to the controller parameters.

9. An electronic device, comprising:
at least one processor; and
a memory communicatively connected to the at least one processor,
wherein the memory stores instructions executable by the at least one processor, and the instructions, when executed by the at least one processor, enables the at least one processor to perform a method for nonlinearly controlling and compensating intermodulation distortion of a sounding element; and
wherein the method for nonlinearly controlling and compensating intermodulation distortion of the sounding element comprises:
acquiring a sound source with an excitation signal obtained by mixing multiple frequencies, and taking test sound pressure response data corresponding to the excitation signal as training set data;
training an intermodulation distortion model with the training set data;
performing intermodulation distortion compensation on at least one sounding element with the trained intermodulation distortion model.

10. The electronic device as described in claim 9, wherein the intermodulation distortion model comprises an identification distortion parameter and a controller parameter, wherein the identification distortion parameter is a parameter representing an intermodulation distortion generated under the excitation signal obtained by mixing the sound source with multiple frequencies, and the controller parameter is a parameter for compensating the intermodulation distortion.

11. The electronic device as described in claim 10, wherein the identifying distortion parameter and controller parameter comprises a time variant linear parameter/a time invariant linear parameter, and/or a time variant nonlinear parameter.

12. The electronic device as described in claim 9, wherein the excitation signal is an audio signal generated by driving an electrical signal, a force signal, or a sound pressure.

13. The electronic device as described in claim 9, wherein the method comprises:
determining controller parameters respectively corresponding to a plurality of sounding elements with the intermodulation distortion model when performing intermodulation distortion compensation on the plurality of sounding elements, the at least one sounding element comprising the plurality of sounding elements;
calculating target compensation signals used to perform intermodulation distortion compensation on the plurality of sounding elements with the controller parameters respectively corresponding to the plurality of sounding elements; and
adding the target compensation signals to a sound source of a target sounding element of the plurality of sounding elements, to perform intermodulation distortion compensation on the plurality of sounding elements.

14. The electronic device as described in claim 13, wherein determining the target sounding element comprises:
selecting, according to control difficulties of the sounding elements, one sounding element, with a low control difficulty, of the plurality of sounding elements as the target sounding element.

15. The electronic device as described in claim 9, wherein the method comprises:
if the sound source of one sounding element of the at least one sounding element comprises contents of different operation regions, determining controller parameters respectively corresponding to the different operation regions with the intermodulation distortion model when the sound source of the sounding element comprises content of different operation regions; and
selecting a corresponding controller parameter of the controller parameters to perform intermodulation distortion compensation according to the operation region of the corresponding sounding element.

16. The electronic device as described in claim 9, wherein the method comprises:
if the sound source of one sounding element of the at least one sounding element comprises contents of different operation regions, determining, using the intermodulation distortion model, controller parameters comprising at least two operation regions of the different operation regions sounding element; and
performing intermodulation distortion compensation according to the controller parameters.

17. A computer readable storage medium storing a computer program, wherein the computer program, when executed by a processor, performs a method for nonlinearly controlling and compensating intermodulation distortion of a sounding element; and
wherein the method for nonlinearly controlling and compensating intermodulation distortion of the sounding element comprises:
acquiring a sound source with an excitation signal obtained by mixing multiple frequencies, and taking test sound pressure response data corresponding to the excitation signal as training set data;
training an intermodulation distortion model with the training set data;
performing intermodulation distortion compensation on at least one sounding element with the trained intermodulation distortion model.

18. The computer readable storage medium as described in claim 17, wherein the intermodulation distortion model comprises an identification distortion parameter and a controller parameter, wherein the identification distortion parameter is a parameter representing an intermodulation distortion generated under the excitation signal obtained by mixing the sound source with multiple frequencies, and the controller parameter is a parameter for compensating the intermodulation distortion.

19. The computer readable storage medium as described in claim 18, wherein the identifying distortion parameter and controller parameter comprises a time variant linear parameter/a time invariant linear parameter, and/or a time variant nonlinear parameter.

20. The computer readable storage medium as described in claim 17, wherein the excitation signal is an audio signal generated by driving an electrical signal, a force signal, or a sound pressure.
